(19) United States
(12) Patent Application Publication
(10) Pub. No.: US 2007/0170037 A1
(43) Pub. Date: Jul. 26, 2007

(54) Lifting machine image monitoring system

(75) Inventor: Shin-ichi Kuroda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/573,853

(22) PCT Filed: Aug. 19, 2004
(86) PCT No.: PCT/JP04/11918

§ 371 Date: Dec. 11, 2006

(51) Int. Cl. B66B 3/00; B66B 5/00; B66B 7/00

(52) U.S. Cl. 198/322; 198/323

(57) ABSTRACT

An elevator supervisory system is obtained which is capable of performing the monitoring of image data of a plurality of monitoring of points at the same time point in an elevator, an escalator or a moving walk at low cost and with ease. The system includes a plurality of monitoring cameras 2a through 2f that output pieces of image data 8a through 8f obtained by taking pictures of the plurality of monitoring points, an image data accumulation device 6a that accumulates individual pieces of image data 8a through 8f in a time series manner, and an accumulated image data display device 6, 6c that displays image data in response to monitoring requests 11, 12 from a user. The image data accumulation device 6a outputs a plurality of pieces of monitoring image data 9a through 9c corresponding to the monitoring requests 11, 12 to the accumulated image data display device 6c. The accumulated image data display device 6, 6c displays, in response to the monitoring points 11 and one piece of reproduction start date and time information 12, pieces of image data 10a through 10c of a plurality of monitoring points at the reproduction start date and time while providing synchronization between the individual pieces of data.

### TECHNICAL FIELD

The present invention relates to an elevating machine supervisory system which is capable of taking pictures of the conditions of elevating machines by means of a plurality of monitoring cameras, accumulating image data at a plurality of monitoring points thus taken, and displaying some plurality of pieces of monitoring image data from among the plurality of pieces of image data thus accumulated in accordance with a monitoring request from a user while synchronizing them with respect to one another.

### BACKGROUND ART

A known elevating machine supervisory system is installed, for example, in the car of an elevator, and is provided with a monitoring camera for taking a picture of the condition of the interior of the car, a storage device for storing the image data thus taken by the monitoring camera, and a central processing unit for copying the image data stored in the storage device to a storage medium (see, for instance, a first patent document).

In the known system as set forth in the above-mentioned first patent document, the central processing unit serves to send the image data stored in the storage device to a wireless handy terminal in response to an instruction through wireless or radio communication from a user, whereby the image data can be displayed on a monitor on the wireless handy terminal, thus making it possible to perform monitoring.
[First Patent Document] Japanese Patent Application Laid-Open No. 2003-201072

### DISCLOSURE OF THE INVENTION

[Problems to be Solved by the Invention]

The known elevating machine supervisory system is constructed as stated above, so in case where monitoring images at multiple locations are to be monitored, it is necessary, as user's preparatory work, to prepare a plurality of handy terminals and to visit a plurality of monitoring locations so as to download monitoring images, thus giving rise to a problem of taking time and trouble to do preparatory work.

In addition, upon monitoring images of multiple locations, it is necessary to perform monitoring by arranging the plurality of handy terminals, to which the monitoring images were downloaded, in parallel with respect to one another and making visual comparisons among individual monitoring images that are reproduced for monitoring on different handy terminals, respectively, as a result of which there is a problem that the user is subjected to a large load.

Further, when monitoring images at multiple locations are monitored, time-related synchronization is not necessarily kept between the monitoring images downloaded to a certain handy terminal and those downloaded to other handy terminals, so there is a problem that it is impossible to monitor the monitoring images at a plurality of locations at the same time point.

[Means for Solving the Problems]

An elevating machine image supervisory system according to the present invention includes: a plurality of monitoring cameras that are separately installed at a plurality of monitoring points, and outputs pieces of image data obtained by taking pictures of conditions of the plurality of monitoring points; an image data accumulation device that accumulates individual pieces of image data output from the plurality of monitoring cameras in a time series manner; and an accumulated image data display device that displays image data accumulated in the image data accumulation device in response to a monitoring request from a user. When the monitoring request is generated, the image data accumulation device outputs a plurality of pieces of monitoring image data corresponding to the monitoring request to the accumulated image data display device. The accumulated image data display device displays, in response to a plurality of monitoring points and one piece of reproduction start date and time information contained in the monitoring request, the plurality of pieces of monitoring image data on the plurality of monitoring points at the reproduction start date and time while providing synchronization between the plurality of pieces of monitoring image data.

[Effects of the Invention]

According to the present invention, by using an accumulated image data display device including a single monitor, it is possible to display, among accumulated image data at a plurality of monitoring points, a plurality of pieces of monitoring image data in accordance with a monitoring request from a user while synchronizing them with respect to one another.

### BRIEF DESCRIPTION OF THE DRAWINGS

FIG. 1 is a block diagram that shows an elevating machine supervisory system according to a first embodiment of the present invention (Embodiment 1).

FIG. 2 is an explanatory view that shows one example of a screen layout configuration displayed on a monitor of a general-purpose personal computer (Embodiment 1).

FIG. 3 is a flow chart that illustrates a processing procedure according to image data accumulation software installed on the general-purpose personal computer (Embodiment 1).

FIG. 4 is a flow chart that illustrates the processing procedure of image data (monitoring image data) display software installed on the general-purpose personal computer (Embodiment 1).

FIG. 5 is a block diagram that shows an elevating machine supervisory system according to a second embodiment of the present invention (Embodiment 2).

FIG. 6 is an explanatory view that shows a relation between refresh rate information and a display interval according to the second embodiment of the present invention (Embodiment 2).

### DESCRIPTION OF THE PREFERRED EMBODIMENTS

The present invention is intended to obviate the problems as referred to above, and has for its object to obtain an elevating machine supervisory system that is capable of performing the monitoring of image data of a plurality of monitoring points at the same time point in an elevator, an escalator or a moving walk at low cost and with ease.

### Embodiment 1

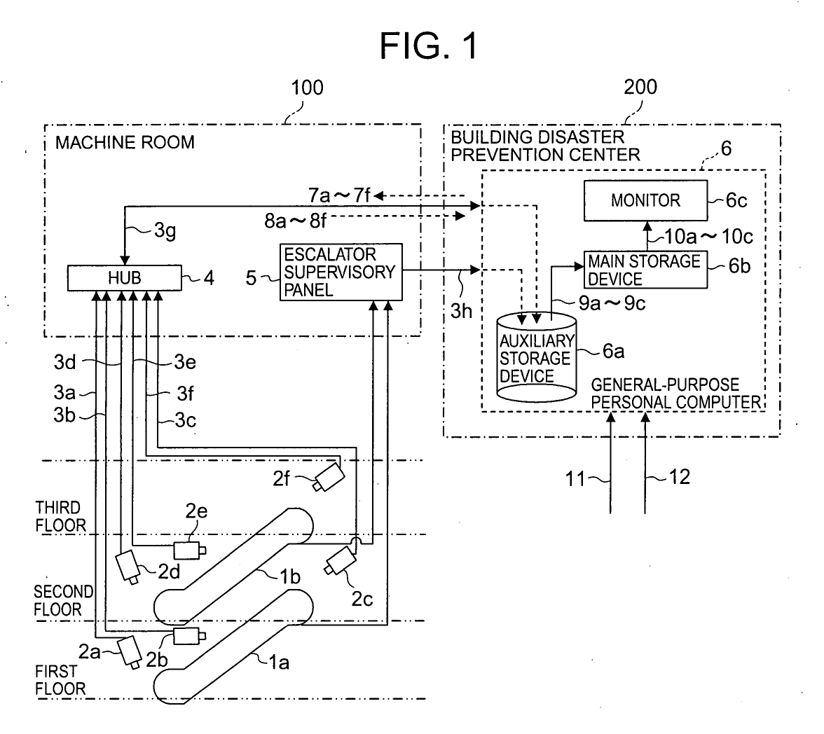

FIG. 1 is a block diagram that shows an elevating machine image supervisory system according to a first embodiment of the present invention, with several locations related to escalators 1a, 1b in a building being made objects to be monitored.

In FIG. 1, individual loading places or entrances, individual unloading places or exits, and locations between the individual entrances and exits of two escalators 1a, 1b are set as a plurality of monitoring points of elevating machines in a building.

Accordingly, network cameras 2a through 2c, 2d through 2f (monitoring camera devices ) are separately installed at the entrances, the exits, and locations between the entrances and exits of the individual escalators 1a, 1b, respectively.

For instance, the escalator 1a is an escalator going up from the first floor to the second floor, and the escalator 1b is an escalator going up from the second floor to the third floor, with the network camera 2a being installed in the entrance of the escalator 1a.

Also, the network camera 2b is installed between the entrance and exit of the escalator 1a, and the network camera 2c is installed in the exit of the escalator 1a.

Similarly, the network camera 2d is installed in the entrance of the escalator 1b, and the network camera 2e is installed between the entrance and exit of the escalator 1b, with the network camera 2f being installed in the exit of the escalator 1b.

In addition, in a machine room 100 of the building where the escalators 1a, 1b are installed, there are arranged a HUB (line concentrator) 4 that is connected to the individual network cameras 2a through 2f through Ethernet (registered trademark) cables (i.e., cables that conform to the Ethernet (registered trademark) standard) 3a through 3h, and an escalator supervisory panel 5 that takes in the operating states of the individual escalators 1a, 1b.

Here, not that the Ethernet (registered trademark) is a standard concerning LAN(Local Area Network) standardized by “the IEEE 802.3 committee”.

On the other hand, a general-purpose personal computer 6 is arranged in a building disaster prevention center 200 of the building where the escalators 1a, 1b are installed.

The general-purpose personal computer 6 is provided with a mass auxiliary storage device 6a composed of a hard disk memory, etc., a main storage device 6b capable of high speed operation for various arithmetic processing, and a monitor 6c that functions as an accumulated image data display device in association with the general-purpose personal computer 6.

Moreover, the general-purpose personal computer 6 has an Ethernet (registered trademark) interface, and is connected with the HUB 4 and the escalator supervisory panel 5 in the machine room 100 through the Ethernet (registered trademark) cables 3g, 3h.

The mass auxiliary storage device 6a, functioning as an image data accumulation device, is connected to the network cameras 2a through 2f through the Ethernet (registered trademark) cables 3g, the HUB 4 and the Ethernet (registered trademark) cables 3a through 3f, and serves to acquire and accumulate pieces of digital compression image data 8a through 8f transferred from the individual network cameras 2a through 2f in a time series manner in accordance with transmission requests 7a through 7f generated in a periodic manner from the general-purpose personal computer 6.

At this time, when the transmission requests 7a through 7f are received through the Ethernet (registered trademark) cables 3g, 3a through 3f, the individual network cameras 2a through 2f serve to input pieces of image data, which were obtained by taking pictures of the individual monitoring points of the individual escalators 1a, 1b, to the mass auxiliary storage device 6a as the pieces of digital compression image data 8a through 8f through the Ethernet (registered trademark) cables 3a through 3f, 3g.

That is, each of the network cameras 2a through 2f has an Ethernet (registered trademark) interface, a function to take pictures of images at the monitoring points, a digital conversion function to digitally convert the image data thus taken, and a digital compression function to compress digital images.

As a result, upon receipt of the transmission requests 7a through 7f for the image data through the Ethernet (registered trademark) cables 3a through 3f, 3g according to a protocol such as for instance an HTTP (Hyper Text Transfer Protocol), the individual network cameras 2a through 2f apply digital conversion processing and digital image compression processing to the images taken at the time point of receipt, and outputs the pieces of digital compression image data 8a through 8f from their Ethernet (registered trademark) interfaces through the Ethernet (registered trademark) cables 3a through 3f, 3g.

Here, a JPEG (Joint Photographic Experts Group) format is given as one example of the compression processing of the image data.

On the other hand, escalator information 11 on escalators which a user wants to monitor, and date and time (date and time point) information 12 at which the user wants to start monitoring are input to the general-purpose personal computer 6 as a monitoring request based on a setting operation of the user.

In addition, the general-purpose personal computer 6 functions, in association with the monitor 6c, as an accumulated image data display device to display the image data accumulated in the mass auxiliary storage device 6a in accordance with the monitoring request.

That is, the general-purpose personal computer 6 output a monitoring request for the digital compression image data concerning the plurality of monitoring points at the reproduction start date and time to the mass auxiliary storage device 6a, in response to the escalator information 11 (the plurality of monitoring points) and one piece of date and time information 12 (the wanted reproduction start date and time) set by the user.

Upon receipt of the monitoring request (user's request), the mass auxiliary storage device 6a outputs, among the accumulated image data (digital compression data), the digital compression data 9a through 9c in the form of objects to be displayed to the monitor 6c through the main storage device 6b.

Also, the mass auxiliary storage device 6a takes in information indicating the operating states of the escalators 1a, 1b from the escalator supervisory panel 5 through the Ethernet (registered trademark) cable 3h, and outputs the operating states of the escalators 1a, 1b along with the pieces of digital compression image data 9a through 9c to the monitor 6c through the main storage device 6b in accordance with the user's request.

That is, the mass auxiliary storage device 6a accumulates the digital compression image data of the individual monitoring points based on the periodic transmission requests 7a through 7f, and when a monitoring request from the user is input, the pieces of digital compression image data 9a through 9c corresponding to the monitoring request are output to and displayed by the monitor 6c through the main storage device 6b.

Specifically, in the general-purpose personal computer 6, the mass auxiliary storage device 6a transfers the pieces of digital compression image data 9a through 9c in the form of objects to be displayed-to the main storage device 6b after accumulating pieces of digital compression image data 8a through 8f transferred from the network cameras 2a through 2f, and the main storage device 6b transfers the pieces of digital compression image data 9a through 9c to the monitor 6c as decoded images 10a through 10c.

At this time, the general-purpose personal computer 6 displays, as the decoded images 10a through 10c, the pieces of digital compression image data 9a through 9c in the form of objects to be displayed from among the digital compression image data accumulated in the mass auxiliary storage device 6a in accordance with the escalator information 11 and the date and time information 12 set by the user.

That is, a plurality of pieces of monitoring image data comprising the decoded images 10a through 10c are displayed by the monitor 6c while being synchronized with one another according to the reproduction start date set by the user.

In the general-purpose personal computer 6 shown in FIG. 1, there are installed image data accumulation software for accumulating the pieces of digital compression image data 8a through 8f in the mass auxiliary storage device 6a and image data display software for displaying image data on the monitor 6c, and it is constructed such that these two pieces of software are processed in time parallel with each other.

The image data display software is executed by the accumulated image data display device, and includes a process of searching for the pieces of digital compression image data 9a through 9c in the form of objects to be displayed out of the mass auxiliary storage device 6a, a process of applying decompression processing to the pieces of digital compression image data 9a through 9c to be displayed thereby to create the decoded images 10a through 10c, and a process of displaying the decoded images 10a through 10c on the monitor 6c.

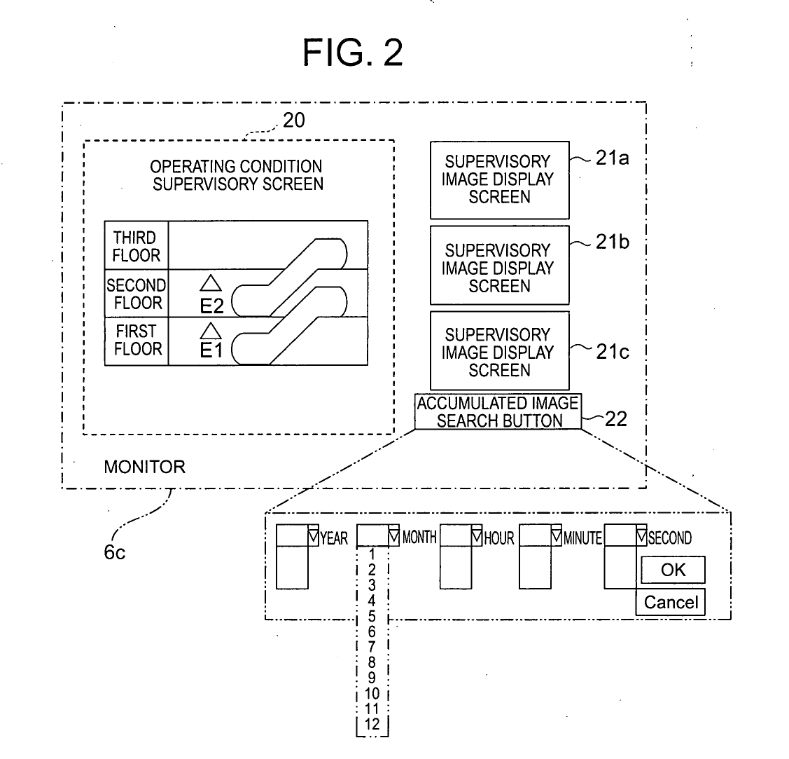

Moreover, in relation to the image data display software, an operating condition supervisory screen 20 (see FIG. 2) that enables the operating states of the escalators 1a, 1b to be monitored is displayed on the monitor 6c of the general-purpose personal computer 6.

In a screen layout configuration shown in FIG. 2, the operating condition supervisory screen 20, supervisory image display screens 21a through 21c and an accumulated image search button 22 are displayed on the monitor 6c.

Accordingly, the user can set a plurality of monitoring points, which the user wants to monitor, by referring to the operating condition supervisory screen 20, for example.

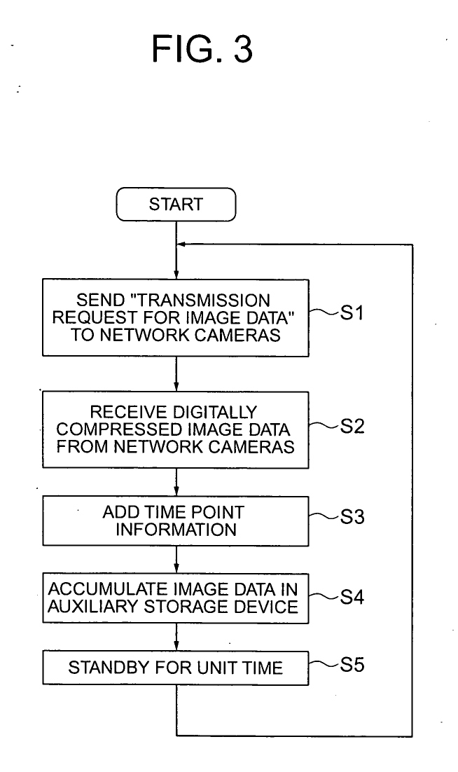

Now, specific reference will be made to the processing procedure according to the image data accumulation (for accumulation of the pieces of digital compression image data 8a through 8f in the mass auxiliary storage device 6a) software in the first embodiment of the present invention shown in FIG. 1 while referring to a flow chart in FIG. 3.

In FIG. 3, first of all, the general-purpose personal computer 6 sends image data transmission requests 7a through 7f to the network cameras 2a through 2f in accordance with a protocol such as the above-mentioned HTTP (step S1).

Also, simultaneously with the processing of the requests in step S1, the general-purpose personal computer 6 stores date and time information at the current point in time in the main storage device 6b.

According to the execution of step S1, the image data transmission requests 7a through 7f are sent to the network cameras 2a through 2f installed at the monitoring points around the escalators 1a, 1b by way of the Ethernet (registered trademark) cable 3g, the HUB 4 in the machine room 100, and the Ethernet (registered trademark) cables 3a through 3f.

Upon receipt of the image data transmission requests 7a through 7f, the network cameras 2a through 2f output the pieces of digital compression image data 8a through 8f to the general-purpose personal computer 6 through the HUB 4, as stated above.

As a result, the general-purpose personal computer 6 receives the pieces of digital compression image data 8a through 8f output from the individual network cameras 2a through 2f (step S2).

Subsequently, the date and time information, being managed by the OS (Operating System) installed in the general-purpose personal computer 6, is added to the pieces of digital compression image data 8a through 8f (step S3), which are then accumulated in the mass auxiliary storage device 6a connected to the general-purpose personal computer 6 (step S4).

Here, note that as one example of the processing method for adding the date and time information to the pieces of digital compression image data 8a through 8f, there is enumerated one in which the names of the pieces of digital compression image data 8a through 8f are created by using the date and time information, and the pieces of digital compression image data 8a through 8f are accumulated in the mass auxiliary storage device 6a by their names.

In addition, as one example of the processing method for accumulation in the mass auxiliary storage device 6a in step S4, there is enumerated one in which storage areas obtained by equally dividing that portion of the storage region of the mass auxiliary storage device 6a which is assigned to the accumulation of the digital compression image data, by the number of the network cameras 2a through 2f (e.g., “6” in the case of FIG. 1) are uniquely associated with the network cameras 2a through 2f, respectively, and the digital compression image data is sequentially accumulated in the divided storage areas in such a manner that after the accumulation into all of these storage areas is finished, new. pieces of data are sequentially accumulated while overwriting the already accumulated pieces of digital compression image data from the oldest ones thereof.

Finally, standby processing is performed for a unit time (step S5), and then a return is carried out to step S1 where transmission requests for the following pieces of image data are made, and thereafter the above-mentioned processing steps S2 through S5 are repeated.

Specifically, in step S5, the time elapsed from the time point at which the processing in step S1 was executed to the current time point is measured by using the date and time information that was stored in the main storage device 6b in step S1, and when the elapsed time becomes equal to the unit time, a return is performed to step S1 where the following image data transmission requests 7a through 7f are sent to the individual network cameras 2a through 2f.

The unit time in step S5 is a value that is shared beforehand by the two pieces of software installed in the general-purpose personal computer 6, and corresponds to an interval from the last transmission time point of the image data transmission requests 7a through 7f to the current transmission time point.

For instance, transmission requests 7a through 7f are sent to the network cameras 2a through 2f two times per second in case where the unit time is set to “500 milliseconds”. In other words, with respect to one network cameras, digital compression image data for two frames per second is accumulated in the mass auxiliary storage device 6a.

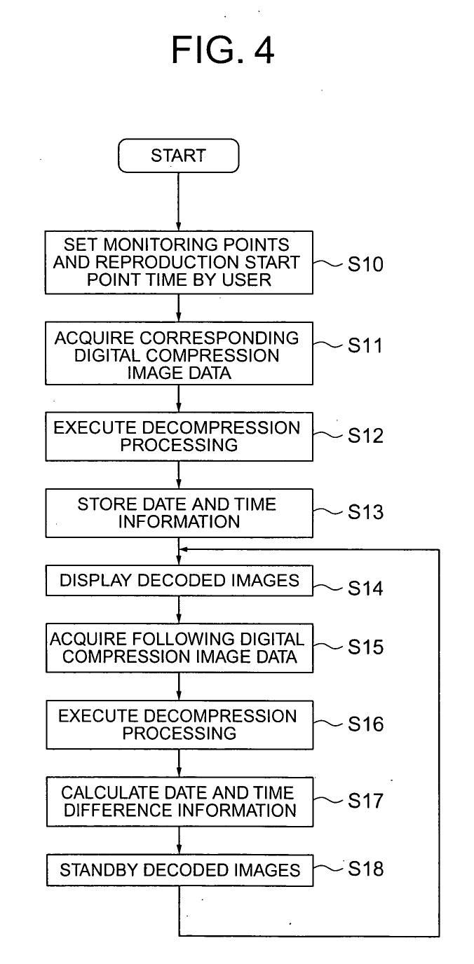

Next, specific reference will be made to the processing procedure according to the image data display software in the first embodiment of the present invention shown in FIG. 1 while referring to a flow chart in FIG. 4 together with FIG. 2.

As stated above, the pieces of digital compression image data 9a through 9c in the form of objects to be displayed are searched out from the digital compression image data accumulated in the mass auxiliary storage device 6a by means of the image data display software, and the decoded images 10a through 10c are created by applying decompression processing to the pieces of digital compression image data 9a through 9c, and are displayed on the monitor 6c.

In addition, the escalator supervisory panel 5 installed in the machine room 100 manages or supervises the operating states of the escalators 1a, 1b, and information to be displayed on the operating condition supervisory screen 20 (see FIG. 2) is obtained from the escalator supervisory panel 5.

In FIG. 4, first, the user selects the escalator information 11 desired for monitoring by clicking a schematic escalator figure on the operating condition supervisory screen 20. Then, the user sets, from among the image data related to the escalator selected above, the date and time information 12 that is wanted to start monitoring, by operating the accumulated image search button 22, and inputs the respective pieces of information 11, 12 to the general-purpose personal computer 6 as a monitoring request (step S10).

As one example of a method for setting the date and time information 12 that is wanted to start monitoring in step S10, there is given one in which the desired “year, month, date, hour, minute and second” are set from a pull-down menu, as shown in FIG. 2.

When the escalator information ii that the user wants to monitor and the date and time information 12 that the user wants to start monitoring are selected by the execution of the step S10, the general-purpose personal computer 6 subsequently acquires the digital compression image data corresponding to the monitoring request (step S11).

That is, the areas in the mass auxiliary storage device 6a in which the digital compression image data of the selected escalator is accumulated are selected, and at the same time, the digital compression image data (monitoring image data) desired by the user among is retrieved from the plurality of pieces of digital compression image data contained in the selected region, and is then transferred to the main storage device 6b.

For instance, it is assumed that, by the user, the schematic drawing of the escalator 1a installed between the first floor and the second floor is selected, and “18:00:05, Nov. 26, 2003” is set as the date and time information 12 that the user wants to start monitoring, with the use of the accumulated image search button 22.

In this case, the software in the general-purpose personal computer 6 recognizes that the pieces of image data taken or photographed by the network cameras 2a through 2c related to the escalator 1a are pieces of monitoring image data, and selects three areas included in the mass auxiliary storage device 6a in which the pieces of digital compression image data 8a through 8c output from the network cameras 2a through 2c are accumulated.

Also, digital compression images with the date and time information of “18:00:05, Nov. 26, 2003” being added thereto are retrieved from the three selected areas, and these retrieval results are output to the main storage device 6b as the pieces of digital compression image data 9a through 9c which become final objects to be displayed.

Following the above step S11, decompression processing is executed on the pieces of digital compression image data 9a through 9c in the form of the objects to be displayed, respectively, (step S12).

As a result, the decoded images 10a through 10c are created.

Subsequently, the date and time information added to the pieces of digital compression image data 9a through 9c in the form of the objects to be displayed is separated, and stored in the main storage device 6b (step S13).

Then, the decoded images 10a through 10c created in step S12 are displayed on the supervisory image display screens 21a through 21c at the same time, and time point information at the current point in time is stored in the main storage device 6b (step S14).

When the displaying of the decoded images 10a through 10c on the supervisory image display screens 21a through 21 in step S14 is finished, new pieces of digital compression image data 9a through 9c, which become the following objects to be displayed, are acquired (step S15).

That is, from among the plurality of pieces of digital compression image data included in the areas selected in step S11, there are retrieved those pieces of digital compression image data which are later in time than the date and time information stored in the main storage device 6b in step S13 and to which the oldest date and time information is added, and these retrieval results are output to the main storage device 6b as the pieces of digital compression image data 9a through 9c in the form of the objects to be displayed.

Subsequently, the pieces of digital compression image data 9a through 9c to be displayed are subjected to decompression processing, respectively, thereby to create the decoded images 10a through 10c (step S16).

In addition, the date and time information added to the pieces of digital compression image data 9a through 9c to be displayed is separated, and date and time difference information between the date and time information thus operated and the date and time information stored in the main storage device 6b in step S13 is calculated (step S16), with the separated date and time information being stored again in the main storage device 6b (step S17).

Finally, displaying of the decoded images 10a through 10c is awaited (step S18), and a return to step S14 is then carried out so that the above-mentioned processing steps S14 through S17 are executed in a repeated manner.

Specifically, in step S18, the time elapsed from the time point at which the processing in step S14 was executed to the current time point is measured by using the date and time information that was stored in the main storage device 6b in step S14, and when the elapsed time becomes equal to the date and time difference information calculated in step S17, the decoded images 10a through 10c created in step S16 are displayed on the supervisory image display screens 21a through 21c, respectively (see FIG. 2), whereby the display contents of the image display screens 21a through 21c are updated.

As described above, according to the first embodiment of the present invention, digital compression image data taken or photographed at a lot of monitoring points are accumulated in the mass auxiliary storage device 6a with date and time information being added thereto, and a plurality of pieces of digital compression image data 9a through 9c in the form of objects to be displayed are retrieved by using, as a search key, monitoring request information given by the user (the escalator information 11 indicating desired monitoring points and the date and time information 12 at which the user wants to start monitoring), whereby a plurality of decoded images 10a through 10c obtained by applying decompression processing to the retrieved pieces of digital compression image data 9a through 9c can be displayed on the monitor 6c at the same time.

Accordingly, there is an advantageous effect that it becomes possible to perform monitoring of monitoring images at multiple locations at the same time point on the single monitor 6c in an easy manner, and hence even when an abnormality such as a failure, an accident or the like occurs, the user can easily know the situation of the escalators 1a, 1b at an abnormality generation point in time.

In addition, since the monitor 6c has the operating condition supervisory screen 20 that makes it possible to monitor the operating states of the escalators, the user can set a plurality of monitoring points at which the user wants monitoring on the operating condition supervisory screen 20.

### Embodiment 2

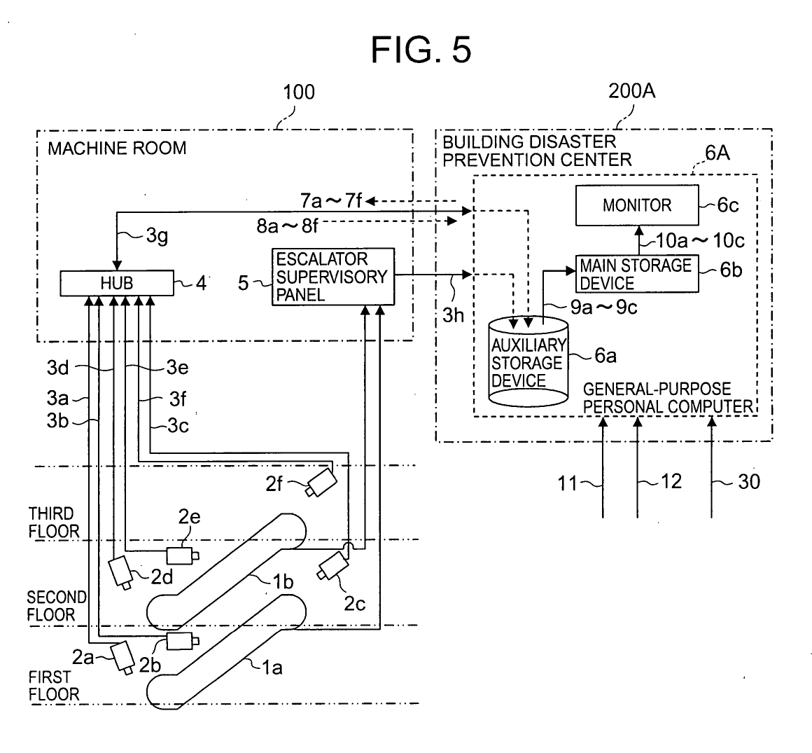

Although in the above-mentioned first embodiment (FIG. 1), it is constructed such that the escalator information 11 and the date and time information 12 are given by the user, reproduction or refresh rate information 30 may be provided, as shown in FIG. 5.

FIG. 5 is a block diagram that illustrates an elevating machine supervisory system according to a second embodiment of the present invention, wherein the parts or components same as those described above (see FIG. 1) are identified by the same symbols or by the same symbols with “A” affixed to their ends, while omitting a detailed explanation thereof.

In FIG. 5, what is different from the above-mentioned one is only in that the refresh rate information 30 is given by the user to a general-purpose personal computer 6A in a building disaster prevention center 200A.

Also, the processing operation of the elevating machine supervisory system according to the second embodiment of present invention is different from the above-mentioned one only in that a step (not shown) of calculating a display interval is added after step S17 in the above-mentioned flow chart (see FIG. 4).

The refresh rate information 30 is information for adjusting a “display interval” between the decoded images displayed on the monitor 6c immediately before and the following decoded images 10a through 10c to be displayed on the monitor 6c, and an actual display interval is calculated by using the refresh rate information 30 and a unit time (see the step S5 in FIG. 3).

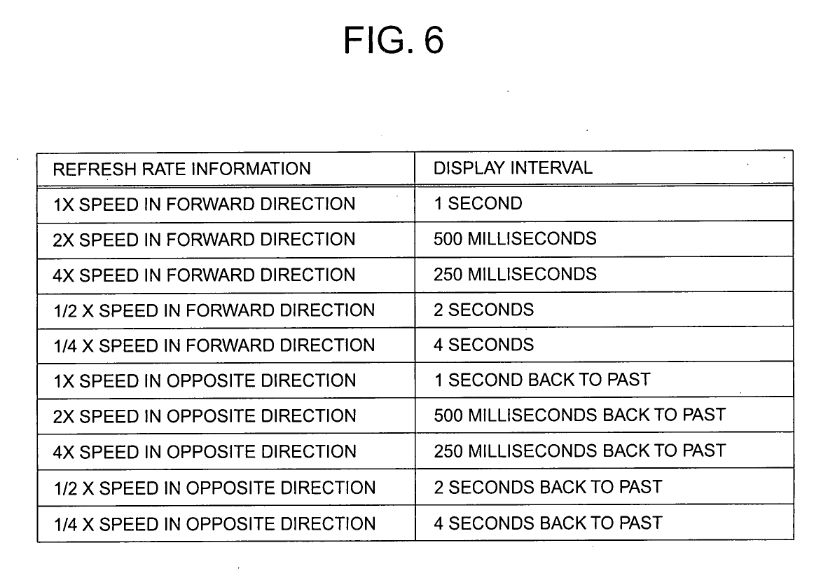

FIG. 6 is an explanatory view that shows a relation between the refresh rate information 30 and the display interval according to the second embodiment of the present invention, wherein for instance, there is illustrated the relation between the refresh rate information 30 and the display interval when the unit time is set to “1 second”.

In FIG. 6, for instance, when the refresh rate information 30 set by the user is a “double (2×) speed in a forward direction”, the display interval becomes “half for one second (=500 milliseconds)”, so the decoded images 10a through 10c can be-displayed on the monitor 6c at high speed.

Also, when the refresh rate information 30 is “a half (½×) speed in a forward direction”, the display interval becomes “twice for one second (=two seconds)”, so the decoded images 10a through 10c can be displayed slowly.

Here, assuming that the storage interval of the image data is represented by T and the drawing interval (display interval) during reproduction is represented by t, specific reference will be made to the reproduction or refresh rate of the image data (relation between the storage interval T and the drawing interval t) corresponding to the refresh rate information 30.

The relation between the storage interval T and the drawing interval t corresponding to the refresh rate information 30 is represented by the following expressions (1) through (3).

That is, when the refresh rate information 30 indicates the “1× speed”, the relation between the storage time T and the drawing interval t becomes as shown in the following expression (1).
T=t (1)

Also, when the refresh rate information 30 indicates the “2× speed”, the relation between the storage time T and the drawing interval t becomes as shown in the following expression (2).
T=t×2 (2)

In expression (2), the drawing interval t becomes the half (½) of the storage interval T, as a result of which the image data is reproduced at a double speed.

Further, when the refresh rate information 30 indicates the “½×speed”, the relation between the storage interval T and the drawing interval t becomes as shown in the following expression (3).
T×2=t (3)

In expression (3), the drawing interval t becomes the double or twice of the storage interval T, as a result of which slow reproduction is made.

On the other hand, when the refresh rate information 30 indicates a “double (2×) speed in the opposite direction”, reverse reproduction is made at the drawing interval t of T/2 (=500 msec) with respect to the storage time T (=1 sec).

Here, note that the “opposite direction ” means going back on a time base to advance in the opposite direction (in the direction of the past), and the “double speed in the opposite direction” means that pieces of image data (decoded images), which were accumulated or stored at the following individual time points (A1)-(A5), are reproduced at a double speed at a drawing or refresh interval t (=500 msec) in the order of (A5)→(A4)→(A3)→(A2)→(A1).

(A1) 15:00:00

(A2) 15:00:01

(A3) 15:00:02

(A4) 15:00:03

(A5) 15:00:04

Hereinafter, specific reference will be made to the processing operation according to the second embodiment of the present invention as shown in FIG. 5 while referring to FIG. 4 along with FIG. 6.

In FIG. 5, after the decoded images 10a through 10c have been displayed on the supervisory image display screens 21a through 21c (see FIG. 2) of the monitor 6c, the general-purpose personal computer 6A executes the processing of step S15 in FIG. 4 by referring to the refresh rate information 30 given by the user when the refresh rate information 30 indicates a “forward direction”.

On the other hand, when the refresh rate information 30 indicates an “opposite direction”, there are retrieved, from among the plurality of pieces of digital compression image data included in the areas selected in step S11 in FIG. 4, those pieces of digital compression image data which are earlier in time than the date and time information stored in the main storage device 6b in step S13 and to which the latest date and time information is added, and these retrieval results are output to the main storage device 6b as the pieces of digital compression image data 9a through 9c which become the objects to be displayed.

Thereafter, the pieces of digital compression image data 9a through 9c to be displayed are subjected to decompression processing, respectively, thereby to create the decoded images 10a through 10c (step S16).

In addition, the date and time information added to the pieces of digital compression image data 9a through 9c to be displayed is separated, and a date and time difference information, which is a difference between the separated date and time information and the date and time information stored in the main storage device 6b in step S13 is created (step S17).

Further, the separated date and time information is stored again in the main storage device 6b, and the display interval is calculated according to FIG. 6 by using the refresh rate information 30 given by the user and the unit time possessed by the software.

Finally, in step S18, the time elapsed from the time point at which the processing in step S14 was executed to the current time point is measured by using the date and time information that was stored in the main storage device 6b in step S14, and when the elapsed time thus measured becomes equal to the display interval previously calculated, the decoded images 10a through 10c created in step S16 are displayed on the supervisory image display screens 21a through 21c, respectively, as shown in FIG. 2, whereby the display contents of the image display screens 21a through 21c are updated.

Here, it can be assumed that display stopping information (not shown), which means the “stop of display”, is given from the user in addition to the refresh rate information 30.

In this case, it is checked, prior to the step S15 in FIG. 4, whether display stopping information has been given by the user, and when display stopping information has not been given, the operation in step S15 is carried out, whereas when display stopping information has been given, the processing operation is made to wait or standby until the following refresh rate information 30 is provided.

As described above, according to the second embodiment of present invention, it is constructed such that in addition to the above-mentioned first embodiment, the refresh rate information 30 on the display interval (display or drawing speed) of the decoded images 10a through 10c is given from the user, so that the display interval of the decoded images 10a through 10c is controlled on the basis of the refresh rate information 30. With such a construction, high-speed reproduction display, slow reproduction display, time ascending display or temporary stop of display can be made for the plurality of the decoded images 10a through 10c while synchronizing them with each other.

Accordingly, there is achieved an advantageous effect that the user can easily know the conditions of the escalators 1a, 1b at the current point in time in a further easy manner.

In addition, when the refresh rate information 30 is set by the user, it is possible to display, on the basis of the refresh rate information 30, a plurality of pieces of image data received from the mass auxiliary storage device 6a that accumulates the image data, while synchronizing them with one another.

Further, when display stopping information is set by the user, the displaying of the plurality of pieces of image data to be displayed can be stopped at the same time.

In the above-mentioned first and second embodiments, the monitoring cameras (network cameras 2a through 2f) are arranged at the entrances, the exits, and locations between the entrances and exits of the individual escalators 1a, 1b, respectively, and the entrances, the exits, and the locations therebetween of the escalators 1a, 1b are made monitoring points, but at least one of entrances, exits and locations therebetween of an arbitrary number of escalators may be set as a monitoring point.

Moreover, although the elevating machines in the form of the escalators 1a, 1b in a building are made objects to be supervised, an arbitrary number of elevators or moving walks may be made objects to be supervised.

For instance, in case where an elevator is made an object to be supervised, a network camera is installed in at least one of a car and a hall of the elevator, and pieces of image data obtained by taking a picture of the condition of the interior of the car or the hall are accumulated, so that when a monitoring request (escalator information 11 and date and time information 12) is set, the decoded images 10a through 10c of corresponding pieces of image data are displayed on the monitor 6c while being synchronized with one another.

Similarly, when a moving walk is made an object to be supervised, a network camera is arranged at at least one of an entrance, an exit and locations between the entrance and exit of the moving walk.

1. An elevating machine image supervisory system comprising:
a plurality of monitoring cameras that are separately installed at a plurality of monitoring points, and outputs pieces of image data obtained by taking pictures of conditions of said plurality of monitoring points;
an image data accumulation device that accumulates individual pieces of image data output from said plurality of monitoring cameras in a time series manner; and
an accumulated image data display device that displays image data accumulated in said image data accumulation device in response to a monitoring request from a user;
wherein when said monitoring request is generated, said image data accumulation device outputs a plurality of pieces of monitoring image data corresponding to said monitoring request to said accumulated image data display device; and
said accumulated image data display device displays, in response to a plurality of monitoring points and one piece of reproduction start date and time information contained in said monitoring request, said plurality of pieces of monitoring image data on said plurality of monitoring points at said reproduction start date and time while providing synchronization between said plurality of pieces of monitoring image data.

2. The elevating machine image supervisory system as set forth in claim 1, wherein said plurality of monitoring points contain the interior of an elevator car or an elevator hall.

3. The elevating machine image supervisory system as set forth in claim 1, wherein said plurality of monitoring points contain an entrance of an escalator, an exit thereof, or a location between said entrance and said exit.

4. The elevating machine image supervisory system as set forth in claim 1, wherein said plurality of monitoring points contain an entrance of a moving walk, an exit thereof, or a location between said entrance and said exit.

5. The elevating machine image supervisory system as set forth in claim 1, wherein
said accumulated image data display device has an operating condition supervisory screen for monitoring the operating condition of an elevator, an escalator or a moving walk; and
said monitoring points are set on said operating condition supervisory screen.

6. The elevating machine image supervisory system as set forth in claim 1, wherein
said monitoring request contains refresh rate information on the display interval of said plurality of pieces of monitoring image data; and
said accumulated image data display device displays said plurality of pieces of monitoring image data transferred from said image data accumulation device on the basis of said refresh rate information.

7. The elevating machine image supervisory system as set forth in claim 1, wherein
said monitoring request contains display stopping information for stopping the displaying of said plurality of pieces of monitoring image data; and
when said display stopping information is set, said accumulated image data display device stops the displaying of said plurality of pieces of monitoring image data at the same time.
